(19) United States
(12) Patent Application Publication
(10) Pub. No.: US 2005/0206662 A1
(43) Pub. Date: Sep. 22, 2005

(54) Receiver and associated printing apparatus

(75) Inventor: Kia Silverbrook, Balmain (AU)

Correspondence Address: SILVERBROOK RESEARCH PTY LTD, 393 DARLING STREET, BALMAIN, 2041, AU

(73) Assignee: Silverbrook Research Pty Ltd, Balmain, NSW (AU)

(21) Appl. No.: 10/503,917

(22) PCT Filed: Feb. 12, 2003
(86) PCT No.: PCT/AU03/00171

§ 371 Date: Aug. 9, 2004

(30) Foreign Application Priority Data
Feb. 13, 2002 (AU) PS 0497

(51) Int. Cl. B41J 3/00

(52) U.S. Cl. 347/2

(57) ABSTRACT

An information retrieval system for retrieving information relating to a broadcast includes a radio frequency receiver and a detector for detecting identifying data relating to a particular broadcast received by the receiver, the identifying data being transmitted in association with the broadcast. A processor is in communication with the detector and processes the identifying data to provide formatted data suitable for printing. A printing unit is associated with the receiver for printing the formatted data to provide information relating to the broadcast.

### FIELD OF INVENTION

This invention relates to an information retrieval system, and more particularly to an information retrieval system, mounted in a conveyance, for retrieving information relating to a broadcast received by a receiver in the conveyance.

In this specification, unless the context clearly indicates otherwise, the term “conveyance” is to be understood in a broad sense as any suitable device for conveying persons and/or goods and includes road vehicles, aircraft, rail vehicles, waterborne craft, spacecraft, or the like.

### BACKGROUND TO THE INVENTION

Increasing numbers of motor vehicles have radio frequency receivers built into them. If not built in, the radio frequency receivers are often added as features of the vehicle after purchase. It is also becoming increasingly popular for such radio frequency receivers to include television receivers.

If a passenger in a conveyance wishes to find out information about a particular broadcast received by such a receiver, that passenger would need to use one of two techniques. Firstly, the passenger hearing or viewing a particular broadcast item would need to remember an announcement, if made, regarding identifying information on that broadcast item in sufficient detail such that the passenger could later use the information contained in said announcement to obtain further information at a later stage.

A second technique involves noting the identification of a transmitter of the broadcast and the time of day at which the broadcast occurred. This information can then be used to contact the broadcaster and to enquire about their schedule in order to identify the broadcast item.

Both techniques have major disadvantages associated with them in that it is necessary for a listener to attempt to memorise information or to write it down while in a moving vehicle. The danger of this, particularly if the listener is also the driver of the vehicle, is self-evident.

Also, it is often easy to miss an announcement due to distraction occurring such as a result of traffic noise or a temporary interference condition causing the broadcast to be interrupted.

Even if the listener did manage to record the details of a broadcast item, obtaining a copy of the broadcast still requires a number of further steps including locating a publication that included the broadcast item and then taking this information to a shop to make the desired purchase (in the event the broadcast was advertising a product or service).

### CO-PENDING APPLICATIONS

Various methods, systems and apparatus relating to fhe present invention are disclosed in the following co-pending applications filed by the applicant or assignee of the present invention on 12 Feb. 2003:

| | | | |
|---|---|---|---|
| PCT/AU03/00154 | PCT/AU03/00151 | PCT/AU03/00150 | PCT/AU03/00145 |
| PCT/AU03/00153 | PCT/AU03/00152 | PCT/AU03/00168 | PCT/AU03/00169 |
| PCT/AU03/00170 | PCT/AU03/00162 | PCT/AU03/00146 | PCT/AU03/00159 |
| PCT/AU03/00171 | PCT/AU03/00149 | PCT/AU03/00167 | PCT/AU03/00158 |
| PCT/AU03/00147 | PCT/AU03/00166 | PCT/AU03/00164 | PCT/AU03/00163 |
| PCT/AU03/00165 | PCT/AU03/00160 | PCT/AU03/00157 | PCT/AU03/00148 |
| PCT/AU03/00156 | PCT/AU03/00155 | | |

The disclosures of these copending applications are incorporated herein by cross-reference.

RELATED PATENT APPLICATIONS AND PATENTS

| | | | |
|---|---|---|---|
| US6,227,652 | US6,213,588 | US6,213,589 | US6,231,163 |
| US6,247,795 | US6,394,581 | US6,244,691 | US6,257,704 |
| US6,416,168 | US6,220,694 | US6,257,705 | US6,247,794 |
| US6,234,610 | US6,247,793 | US6,264,306 | US6,241,342 |
| US6,247,792 | US6,264,307 | US6,254,220 | US6,234,611 |
| US6,302,528 | US6,283,582 | US6,239,821 | US6,338,547 |
| US6,247,796 | US09/113,122 | US6,390,603 | US6,362,843 |
| US6,293,653 | US6,312,107 | US6,227,653 | US6,234,609 |
| US6,238,040 | US6,188,415 | US6,227,654 | US6,209,989 |
| US6,247,791 | US6,336,710 | US6,217,153 | US6,416,167 |
| US6,243,113 | US6,283,581 | US6,247,790 | US6,260,953 |
| US6,267,469 | US6,273,544 | US6,309,048 | US6,420,196 |
| US6,443,558 | US09/422,892 | US6,378,989 | US09/425,420 |
| US09/422,893 | US09/609,140 | US6,409,323 | US6,281,912 |
| US09/575,113 | US6,318,920 | US6,488,422 | US09/693,644 |
| US6,457,810 | US6,485,135 | US09/112,763 | US6,331,946 |
| US6,246,970 | US6,442,525 | US09/505,951 | US09/505,147 |
| US09/505,952 | US09/575,108 | US09/575,109 | US09/575,110 |
| US09/607,985 | US6,398,332 | US6,394,573 | US09/606,999 |
| US6,238,044 | US6,425,661 | US6,390,605 | US6,322,195 |
| US09/504,221 | US6,480,089 | US6,460,778 | US6,305,788 |
| US6,426,014 | US6,364,453 | US6,457,795 | US09/556,219 |
| US09/556,218 | US6,315,399 | US6,338,548 | US09/575,190 |
| US6,328,431 | US6,328,425 | US09/575,127 | US6,383,833 |
| US6,464,332 | US6,390,591 | US09/575,152 | US6,328,417 |
| US6,322,194 | US09/575,177 | US09/575,175 | US6,417,757 |
| US09/608,780 | US6,428,139 | US09/607,498 | US09/693,079 |
| US09/693,135 | US6,428,142 | US09/692,813 | US09/693,319 |
| US09/693,311 | US6,439,908 | US09/693,735 | PCT/AU98/00550 |
| PCT/AU00/00516 | PCT/AU00/00517 | PCT/AU00/00511 | PCT/AU00/00754 |
| PCT/AU00/00755 | PCT/AU00/00756 | PCT/AU00/00757 | PCT/AU00/00095 |
| PCT/AU00/00172 | PCT/AU00/00338 | PCT/AU00/00339 | PCT/AU00/00340 |
| PCT/AU00/00341 | PCT/AU00/00581 | PCT/AU00/00580 | PCT/AU00/00582 |
| PCT/AU00/00587 | PCT/AU00/00588 | PCT/AU00/00589 | PCT/AU00/00583 |
| PCT/AU00/00593 | PCT/AU00/00590 | PCT/AU00/00591 | PCT/AU00/00592 |
| PCT/AU00/00584 | PCT/AU00/00585 | PCT/AU00/00586 | PCT/AU00/00749 |
| PCT/AU00/00750 | PCT/AU00/00751 | PCT/AU00/00752 | PCT/AU01/01332 |
| PCT/AU01/01318 | PCT/AU00/01513 | PCT/AU00/01514 | PCT/AU00/01515 |
| PCT/AU00/01516 | PCT/AU00/01517 | PCT/AU00/01512 | PCT/AU01/00502 |
| PCT/AU02/01120 | PCT/AU00/00333 | PCT/AU01/00141 | PCT/AU01/00139 |
| PCT/AU01/00140 | PCT/AU00/00753 | PCT/AU01/01321 | PCT/AU01/01322 |
| PCT/AU01/01323 | PCT/AU00/00594 | PCT/AU00/00595 | PCT/AU00/00596 |
| PCT/AU00/00597 | PCT/AU00/00598 | PCT/AU00/00741 | PCT/AU00/00742 |

### SUMMARY OF THE INVENTION

According to a first aspect of the invention, there is provided an information retrieval system for retrieving information relating to a broadcast received by a receiver, the system including:
a radio frequency receiver;
a detecting means for detecting identifying data relating to a particular broadcast received by the receiver, the identifying data being transmitted in association with the broadcast;
a processing means, in communication with said detecting means, for processing said identifying data to provide formatted data suitable for printing; and
a printing unit associated with said receiver for printing said formatted data to provide information relating to said broadcast.

Preferably, the receiver is mounted in a conveyance and the printing unit is installed in said conveyance.

The identifying data may comprise an identifying tag associated with the particular broadcast. Then, the detecting means may comprise a tag look-up unit.

The broadcast may be by way of an analog audio signal and the identifying data may be inserted into the signal. Instead, the broadcast may be by way of a digital audio signal and the identifying data may be inserted into an allocated data component of the signal. Still further, the broadcast may be by way of an analog video signal and the identifying data may be inserted into the signal during a blanking period of the signal. Yet a further possibility may be that the broadcast is by way of a digital video signal and the identifying data may be inserted into an allocated data component of the signal.

The receiver may include an actuating means operable by a user to activate the detecting means to detect the identifying data and to send the identifying data to the printing unit for printing.

The processing means may include a layout engine in communication with the detecting means. The layout engine may lay out data elements to be communicated to the printer so that, when printed on a suitable print media, the data are presented in a visually discernible form.

The processing means may further comprise a data manipulating means in communication with the layout engine for manipulating the data to provide the formatted data.

The printing unit may include a printer controller, for receiving the formatted data to be printed, and a printer. The printer may be a full color printer. Preferably, the printer is a photo quality color printer.

Still further, the printer may be an ink jet printer. Thus, the printer may comprise a pagewidth inkjet printhead. The printhead may comprise an array of nozzles, said array being fabricated by microelectromechanical techniques.

According to a second aspect of the invention, there is provided a method of retrieving information relating to a broadcast received by a receiver, the method including the steps of
receiving a broadcast on a radio frequency receiver;
detecting identifying data relating to a particular broadcast received by the receiver, the identifying data being transmitted in association with the broadcast;
processing said identifying data to provide formatted data suitable for printing; and
printing said formatted data to provide information relating to said broadcast.

Preferably, the receiver is mounted in a conveyance and the method includes mounting a printer in the conveyance and printing the information via said printer.

The method may include transmitting the identifying data as a tag associated with the particular broadcast. Then, the method may include detecting the tag by means of a tag look-up unit.

The broadcast may be by way of an analog audio signal and the method may include inserting the identifying data into the signal. Instead, the broadcast may be by way of a digital audio signal and the method may include inserting the identifying data into an allocated data component of the signal. Still further, the broadcast may be by way of an analog video signal and the method may include inserting the identifying data into the signal during a blanking period of the signal. Yet a further possibility may be that the broadcast is by way of a digital video signal and the method may include inserting the identifying data into an allocated data component of the signal.

The method may include activating the detecting means to detect the identifying data and to send the identifying data to the printing unit for printing.

Further, the method may include manipulating said identifying data prior to printing to provide said formatted data.

According to a third aspect of the invention, there is provided an information retrieval system for retrieving information relating to a broadcast received by a receiver installed in a vehicle, the system including:
a radio frequency receiver;
an onboard detecting means for detecting identifying data relating to a particular broadcast received by the receiver, the identifying data being transmitted in association with the broadcast;
a processing means, in communication with said detecting means, for processing said identifying data to provide formatted data suitable for printing; and
an onboard printing unit for printing said formatted data to provide information relating to said broadcast.

In this specification, unless the context clearly indicates otherwise, the term “onboard” is to be understood in a broad sense as a device and its components, which are mounted in a conveyance.

According to a fourth aspect of the invention, there is provided a method of retrieving information relating to a broadcast received by a receiver installed in a vehicle, the method including the steps of:
detecting identifying data relating to a particular broadcast received by the receiver, the identifying data being transmitted in association with the broadcast;
processing said identifying data to provide formatted data suitable for printing; and
printing said formatted data on an onboard printing unit.

According to a fifth aspect of the invention, there is provided an information retrieval system for retrieving information relating to a broadcast received by a receiver installed in a vehicle, the system including:
a radio frequency receiver;
a tag identifying means for detecting and identifying an identifying tag transmitted in association with a particular broadcast received by the receiver;
an activating means, connected to the tag identifying means, operable by a user to activate the tag identifying means when the user wishes to obtain information relating to the broadcast;
a layout engine responsive to the tag identifying means for processing identifying data generated by the tag identifying means at least into textual data;
a pre-printing processing means which is connected to the layout engine and which processes the data to provide formatted data which is in a format which is suitable for printing; and
an onboard printer for printing the formatted data, on demand, to provide a hard copy of the information relating to the broadcast.

According to a sixth aspect of the invention, there is provided a method of retrieving information relating to a broadcast received by a receiver installed in a vehicle, the method including:
receiving a particular broadcast on a radio frequency receiver;
detecting and identifying, by way of a tag identifying means, an identifying tag transmitted in association with the broadcast;
activating the tag identifying means when the user wishes to obtain information relating to the broadcast;
processing identifying data generated by the tag identifying means at least into textual data;
processing the textual data to provide formatted data which is in a format which is suitable for printing; and
printing the formatted data, on demand, via an onboard printer contained in the vehicle, to provide a hard copy of information relating to the broadcast.

### BRIEF DESCRIPTION OF THE DRAWINGS

A preferred embodiment of the invention will now described, by way of example only, with reference to the accompanying drawings, in which:

FIG. 1 shows a block diagram of an information retrieval system, in accordance with the invention, for retrieving information relating to a broadcast;

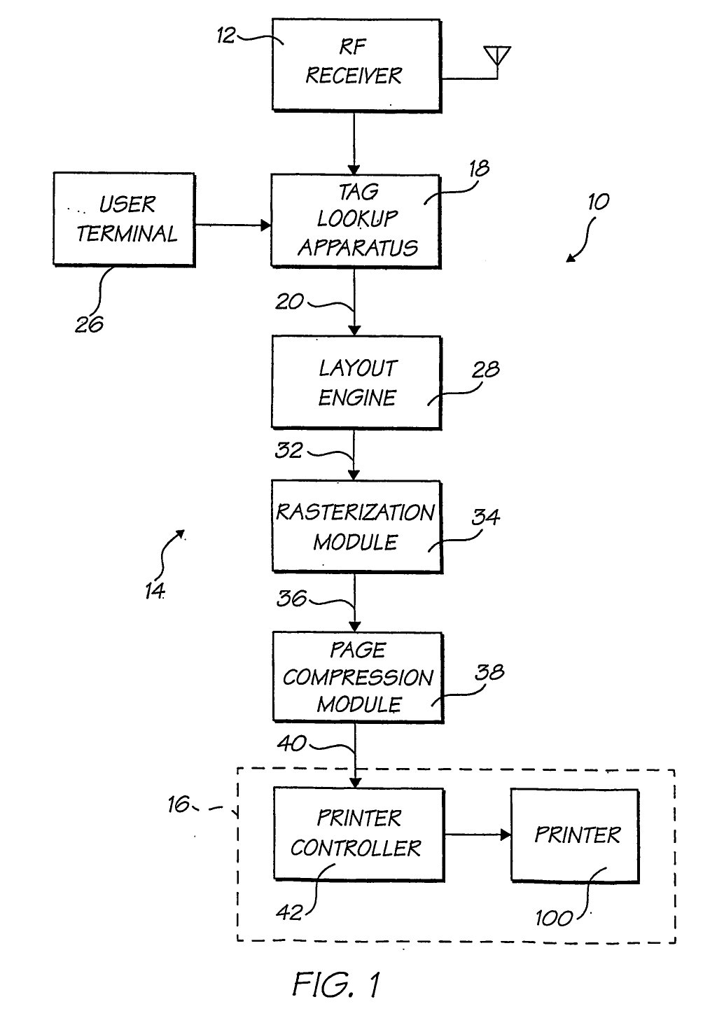

FIG. 2 shows a three dimensional view of a printer for use with the system;

FIG. 3 shows a three dimensional view of the printer with a cover removed;

FIG. 4 shows a three dimensional, exploded view of the printer;

FIG. 5 shows a sectional side view of the printer;

FIG. 6 shows a three dimensional view of a cartridge for the printer;

FIG. 7 shows a three dimensional, exploded view of the cartridge;

FIG. 8 shows a three dimensional, schematic view of a nozzle assembly for an ink jet printhead for the printer;

FIGS. 9 to 11 show a three dimensional, schematic illustration of an operation of the nozzle assembly of FIG. 8;

FIG. 12 shows a three dimensional view of a nozzle array constituting the printhead;

FIG. 13 shows, on an enlarged scale, part of the array of FIG. 12;

FIG. 14 shows a three dimensional view of the printhead including a nozzle guard; and

FIG. 15 shows a three dimensional view of an implementation of the information retrieval system.

### DETAILED DESCRIPTION OF THE PREFERRED EMBODIMENT

Referring to the drawings, an information retrieval system, in accordance with the invention, for retrieving information relating to a broadcast received by a receiver is designated generally by the reference numeral 10. The system 10 comprises a radio frequency receiver 12. A detecting apparatus in the form of a tag look up unit 18 is connected to an output of the receiver 12. A user terminal 26 is connected to the tag look up unit 18. A processing means 14 is connected to an output of the tag look up unit 18.

The processing means 14 comprises a layout engine 28, which receives page content and layout on a line 20 from the tag look up unit 18. The layout engine 28 manipulates the data received from the unit 18 and transmits a page description on line 32 to a rasterization module 34 of the processing means 14. A rasterized page is output from the rasterization module 34 on line 36 to a page compression module 38 of the processing means 14.

A printing unit 16 is connected to an output of the page compression module 38. The printing unit 16 comprises a printer controller 42, which receives a compressed page output from the page compression module 38. The printer controller 42, in turn, controls a printer 100 for printing out the required information.

The type of information encoded with a broadcast will depend on the type of broadcast in question.

As indicated above, the receiver 12 could be a radio receiver or a television receiver. In addition, the broadcast could be an analog broadcast or a digital broadcast.

In the case of an analog audio broadcast, there is redundancy in the audio signal, which can be identified by a psycho-acoustic model that typically is used as part of well-known audio compression techniques. Portions of the spectrum generally corresponding to unperceivable portions of a signal may be removed and replaced with encoded data without affecting the perceived quality of the audio signal. In addition to the replacement of existing portions of the signal, it is also possible to identify regions within the spectrum into which data can be injected without affecting the perceived audio quality. By a suitable method of encoding a subsidiary signal within these portions of the spectrum, it is possible to insert data to encode such data as song titles, artists and other pertinent details of a broadcast.

In the case of a digital audio signal, a digital audio broadcasting standard is presently being implemented although, at present, the availability of receivers that comply with the standard is limited. This standard specifies an allocation bandwidth that is split into data and audio components. The data component is eminently suitable for encoding ancillary data that may be broadcast along with the audio transmission. Once again, the data component could include matter that is relevant to the particular broadcast.

Similarly, in the case of a television transmission, a number of techniques can be used for encoding additional information either through the characteristics of the signal or by using an existing standard.

In the case of an analog television transmission, there is a period of time known as the vertical blanking period during which no display data are transmitted. Additional information can easily be encoded in the television broadcast signal during the time of the vertical blanking period without disturbing the video image or audio signal.

In the case of digital television, there are currently being adopted standards that provide datacasting facilities in addition to image broadcasting. The datacasting facility is, once again, suitable for encoding additional information into a digital television broadcast.

With the inclusion of additional information within a broadcast, it is possible to encode data in the broadcast stream that is of use to the user once extracted. One possibility is to encode a simple set of data in the broadcast stream such as representations of the name of the broadcaster and some further details about the content being broadcast. Another example of data that could be encoded in the broadcast stream is a tag (such as a URL), which can be used to access or index a secondary service. The secondary service could then provide more information about the broadcast and could possibly contain further tags leading to additional or supplementary information.

The inclusion of the printer 10 and associated user terminal 26 in the vehicle allows a listener to access the data associated with the broadcast in printed form for use as desired.

Certain of the components of the system 10 are now described in greater detail.

The layout engine 28 may be required to manipulate data sourced from a plurality of sources. This data may have no embedded layout information. Depending on the kind of content supplied, it may be necessary to firstly create a formatted description of the content that can then be used to generate one or more pages of page description language.

The page description language to be generated by the layout engine 28 determines the kinds of data elements, and the structuring of elements that may be used to compose a page. For example, if the page description language used is postscript, then the elements that are used to describe the page include filled and stroked paths consisting of line segments and curves, text with corresponding font definitions, and images.

A template for laying out data may be dynamically generated by the layout engine 28 based on user choices, may be a static built-in template, or may even be obtained from some other source such as the source supplying the data.

A number of possibilities exist for layout and content descriptions that can be used to generate a set of consistent layouts for a page containing a number of elements that may be both textual and graphical.

One example of a method of data layout that allows data to be sourced from a plurality of separate locations is through using a combination of XML (eXtensible Markup Language) and XSL (eXtensible Stylesheet Language).

XML allows content to be marked up by applying a set of tags to the content. The definition of each tag in particular XML content is described in a separate scheme referenced by the XML.

XSL provides a method of transforming XML into another format (for example HTML) whilst simultaneously performing selection and filtering operations.

The combination of XML content and XSL as a layout specification allows for descriptions of one or more pages to be produced in a formatting language. The formatting language may then be translated into a page description language suitable for printing (ie, one that provides descriptions of objects, their locations and compositing details).

Another possible layout and content description which can be used is a document which is specified in HTML (Hyper Text Markup Language) which is supplied to the layout engine 28 for the purposes of creating a page description. One or more stylesheets specified according to CSS (Cascading Style Sheet) standard may also be supplied, allowing the layout engine 28 to associate a supplied style with a set of tags. If no style sheet is supplied a set of default styles internal to the layout engine 28 is adopted.

The HTML document is then translated into a page description language suitable for printing.

The rasterization module 34 is provided to convert from page description language into a format that can be sent to the print engine (not shown) of the printer 100. This format may take a number of forms depending on the characteristics of the print engine such as the color gamut of the output device, the types of markers to be used, the number of markers being used (and their respective colors) and the medium being marked.

The page description received by the rasterization module 34 may also take a number of forms. Many page description languages are program oriented in that a page is described in a pragmatically generated manner. Other page description languages describe pages in terms of a set of objects placed on a page by way of a painter's algorithms. Still other page description languages describe a page in terms of a compositing model that defines a hierarchy of objects located on a page, each with a defined compositing order relative to a neighborhood of other objects.

A number of ways exist in which rasterization of a page, a set of pages, a sub-set of objects on a page or a sub set of objects on a number of pages may be processed by the rasterization module 34.

One method of rasterization involves a divide-and-conquer approach in which the page description language is initially interpreted to form a model of the page. The page is scanned and objects are rasterized as they are encountered and then composited to form pixmap output for a portion of the page. The pixmap is then mapped into the color space of the output device or dithered (or error defused) to match the characteristics required by the output device.

Another method of rasterization which may be employed by the rasterization module 34 is to render each object in fill or partially according to the type of object the coverage of the object with respect to the page (and the portion of the page currently being rendered) and caching aspects of the object For instance, if a character string is to be rasterized, each character in the string may be rasterized in full and then cached for later reuse whereas a filled rectangle may only be rasterized as necessary.

Depending on the output requirements for the rasterization module 34, each page to be rasterized may be generated in its entirety or generated in a band wise fashion for forwarding to the page compression module 38. In this way, if a page is larger than a certain size, and memory needs to be conserved, a page may be divided into a number of bands that may be rasterized on demand.

The page compression module 38 is provided to reduce the amount of rasterized page data that needs to be transferred to the printer controller 42. The page data is compressed using one or more of a number of techniques that do not result in a visible degradation in the quality of the final printed image.

A method of compressing contone data is JPEG compression. With this compression technique, contone pixels are converted into a luminance/chrominance representation that may then efficiently be compressed by using quantization of a discrete cosine transformation of the data. This quantized version of the data is entropy coded to reduce large runs of zero valued elements resulting in an overall 10:1 reduction in data size with virtually no resulting significant loss of image quality.

The wavelet transform, as adopted by the JPEG 2000 standard, is a method used to compress contone data. Two different wavelet transforms are specified by JPEG 2000, namely, a 9/7 wavelet transform for lossy compression and a 5/3 3 wavelet transform for lossless compression. Given that the results of compression using the 9/7 wavelet transform are visually superior to the results of compression using the discrete cosine transform, it is reasonable to expect that a compression ratio of at least 50:1 can be achieved without significant degradation of the reconstructed image.

The scan order adopted by JPEG 2000 is a spiral scan of the original image, traversed one pixel at a time. This is not convenient for printing applications since it would require that the complete page be decoded and stored or that the page be decoded multiple times for printing to be carried out. To remedy this, it may be possible to adopt an alternative scan order that traverses each image row in sequence such that each portion of the image received can be immediately decoded and printed independently of the receipt of the complete compressed page.

Compression of bilevel images may be performed by using the commonly known Group 3 or Group 4 fax algorithms. These algorithms exploit the two dimensional properties of typical bilevel images to achieve an average 30:1 compression.

The JBIG (Joint Bilevel Image Group) has defined a method for the compression of bilevel images called JBIG2 that is able to yield higher compression ratios than the older Group 3 and Group 4 fax algorithms with a more complex encoder/decoder combination. Essentially JBIG2 relies on the encoder to successfully segment an input image into a number of regions that are compressed with techniques specialised according to the properties of the region being encoded. Regions that contain text elements are encoded using an algorithm that stores encoded versions of bitmaps corresponding to each character. Regions that contain half toned images particularly for the case when ordered half toning has been used) are encoded by storing a dictionary of half toned patterns and the regions to which they apply. Regions that contain other elements such as line art are encoded into a compressed bitmap representation.

In certain instances, page compression may not be required. In that case, the page compression module 38 functions using null compression wherein the page is not compressed at all and the page compression module 38 functions as a pass through module.

The printer controller 42 is responsible for handling the hardware specific aspects of the printing process. This enables a number of different types of printing mechanisms or printers 100 to be adopted without changing details of the system further up the chain of print modules.

The printer controller 42 receives a rasterized version of each page which is usually compressed using one of the compression techniques described above. The page may be received in its entirety or in a band-wise fashion depending on the size of the page and the functioning of the preceding modules 34 and 38.

In the printer controller 42, the page data are progressively accessed in printer order, decompressed if required and organised into a format suitable for hardware of the printer 100 to enable the hardware of the printer 100 to program its printhead 300. This recognition may include such factors as may be necessary to account for special characteristics of a particular printhead 300 such as up scaling and dithering of the print data and adjustments, if necessary, for the markers and paper being used.

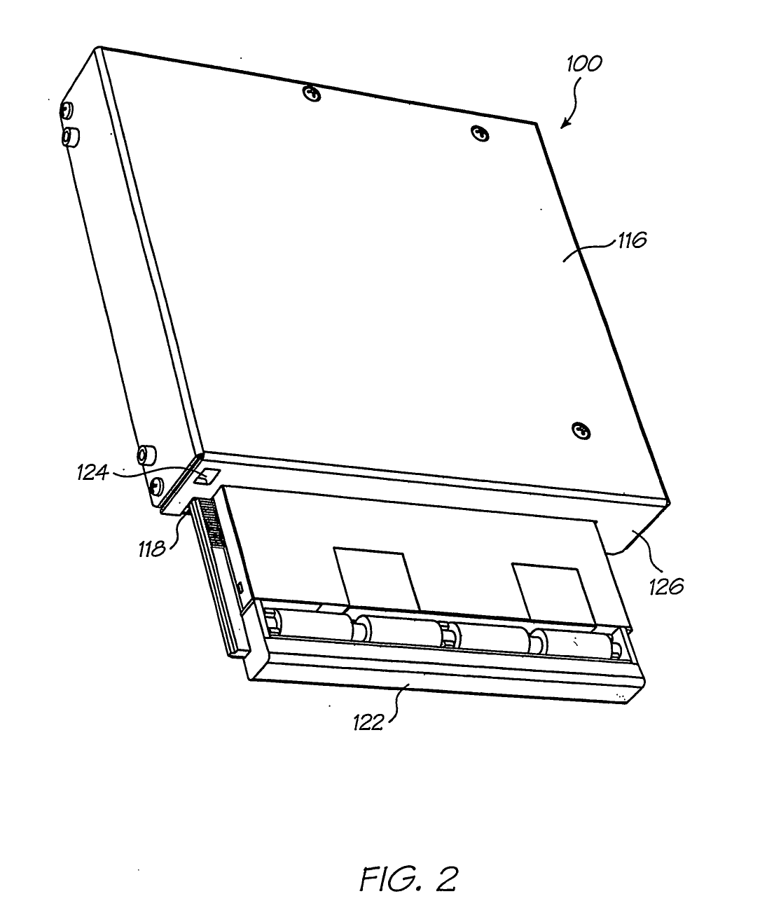

Referring to FIGS. 2 to 7 of the drawings, the printer 100 is described in greater detail.

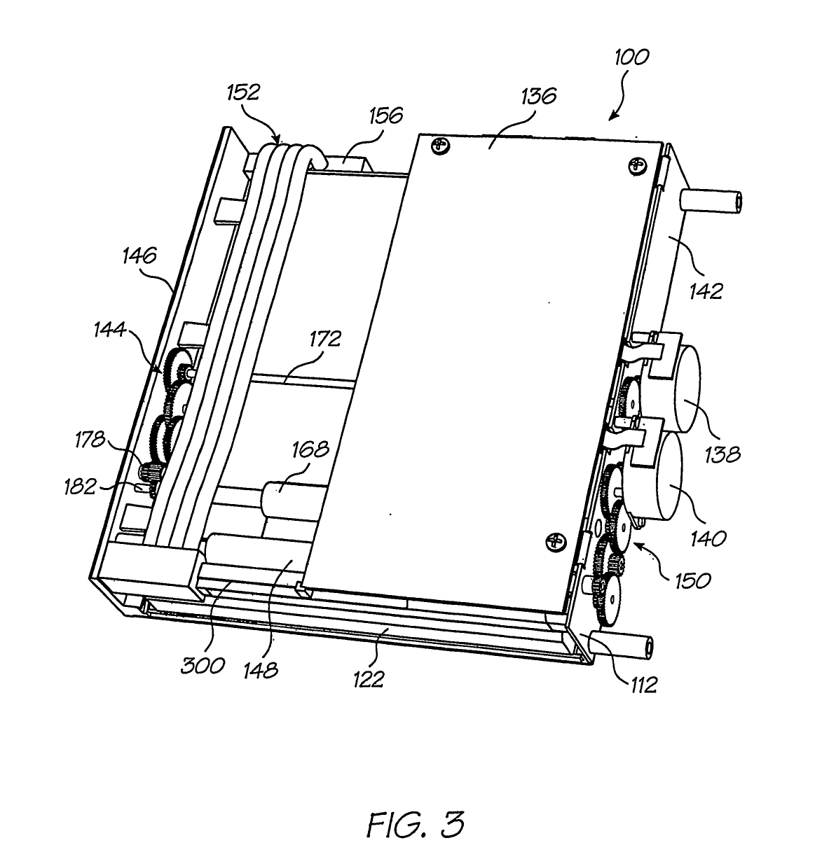

The printer 100 includes a chassis 112 (FIG. 3) which is covered by a top cover 116, that has an access opening 118 closed off by a flap 120. The flap 120 is spring biased so that, when a cartridge 122 has been removed from the printer 100, the flap is urged upwards to close off the access opening 118.

The device that sends commands to the printer 100 can either be hard wired to the printer 100, for example, via a wiring loom of the motor vehicle or, instead, the device may send commands to the printer 100 in a wireless manner. For this purpose, the printer 100 includes a port 124 able to detect wireless communications, such as infra-red communications.

The printer 100 incorporates a printhead 300 (FIG. 3). The printhead 300 is a pagewidth ink jet printhead. More particularly, the printhead 300 is a four color printhead, or three color plus infra red ink, printhead which prints photo quality prints on print media stored in the cartridge 122. The printhead 300 comprises an array of nozzles to provide printing at 1600 dpi. The nozzles of the printhead 300 are manufactured using the applicant's Memjet technology. The printhead is described in greater detail below.

The printhead 300 receives commands from a printed circuit board (PCB) 136 secured to the chassis 112.

A pair of drive motors 138 and 140 are mounted on a sidewall 142 of the chassis 112. The drive motor 138, which is in the form of a stepper motor, drives a first drive arrangement in the form of a first gear train 144. The first gear train 144 is mounted on a side molding 146 of the chassis 112.

The drive motor 140, which is also in the form of a stepper motor, drives a drive roller 148 via a second drive arrangement in the form of a second gear train 150.

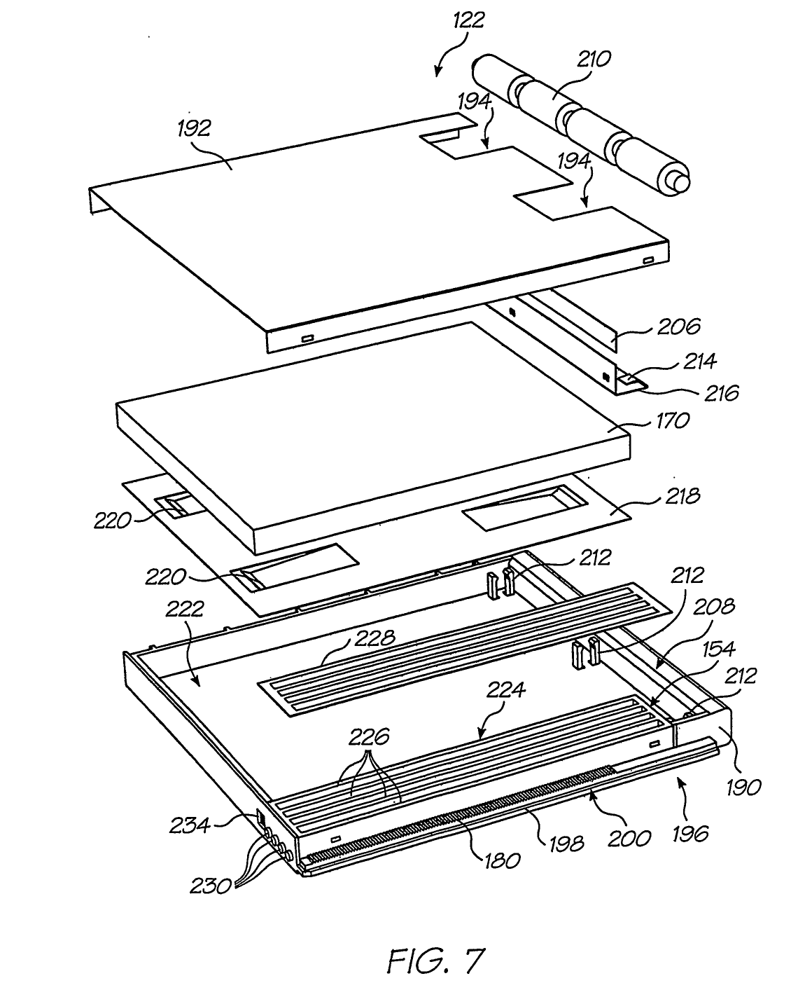

The printhead 300 receives ink from ink hoses 152 which communicate with an ink supply reservoir 154 (FIG. 7) of the cartridge 122 via an ink supply manifold 156, as will be described in greater detail below.

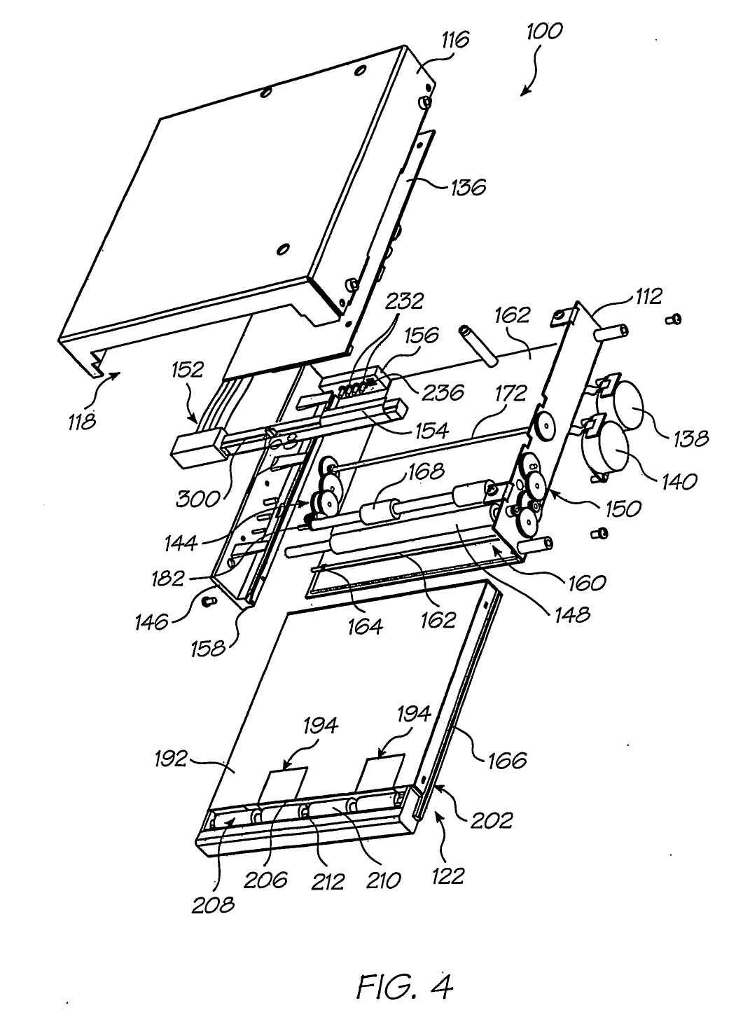

Referring to FIG. 4 of the drawings, an exploded view of the printer 100 is illustrated. It is to be noted that the printhead 300 communicates with the PCB 136 via a TAB film 154.

A slot 158 is defined in the side molding 146. The slot 158 receives a corresponding formation of the cartridge 122 in it. Further, a roller set 160 is mounted on a base 162 of the printer 100. The roller set 160 comprises a rotatable axle 162. A cog 164 is mounted proximate each end of the axle 162. Each cog 164 engages a longitudinally extending rack 200, 202, one on each side of the cartridge 122, for inhibiting skewing of the cartridge 122 as it is inserted into, or withdrawn from, the printer 100.

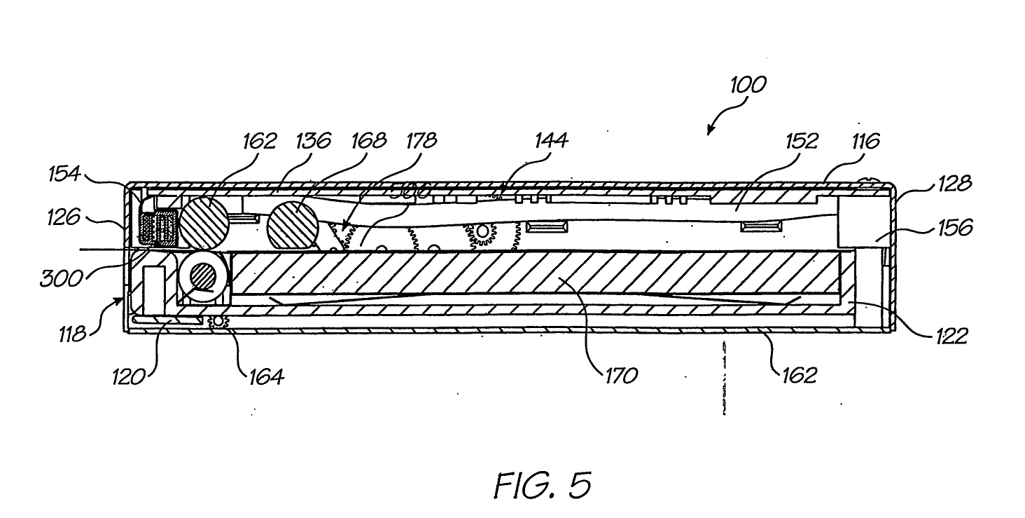

The first gear train 144 engages a pick up roller 168 of the printer 100. The pick up roller 168 picks up print media in the form of a sheet of paper from a stack 170 of paper (FIG. 5) in the cartridge 122 for feeding to the printhead 300 of the printer 100 when printing is to be effected.

As shown in greater detail in FIG. 4 of the drawings, the first gear train 144 is powered by the stepper motor 138 via an axle 172 extending across the printer 100 to convey power from the stepper motor 138 to the first gear train 144. A gear 174 is mounted against the molding 146 at one end of the axle 172. The gear 174 drives a reduction gear set 176. Further, the reduction gear set 176 communicates with a reversing mechanism 178. Accordingly, the gear train 144 performs two functions. When the reversing mechanism 178 is not selected, the gear train 144 engages an upper rack 180 on the cartridge 122 for feeding the cartridge 122 into the printer 100 or ejecting the cartridge 122 from the printer 100. Instead, when the reversing mechanism has been selected, it engages the pick up roller 168 or, more particularly, a gear 182 mounted at an end of the pick up roller 168. The gear train 144 then serves to feed the paper to the drive roller 148 for conveying to the printhead 300.

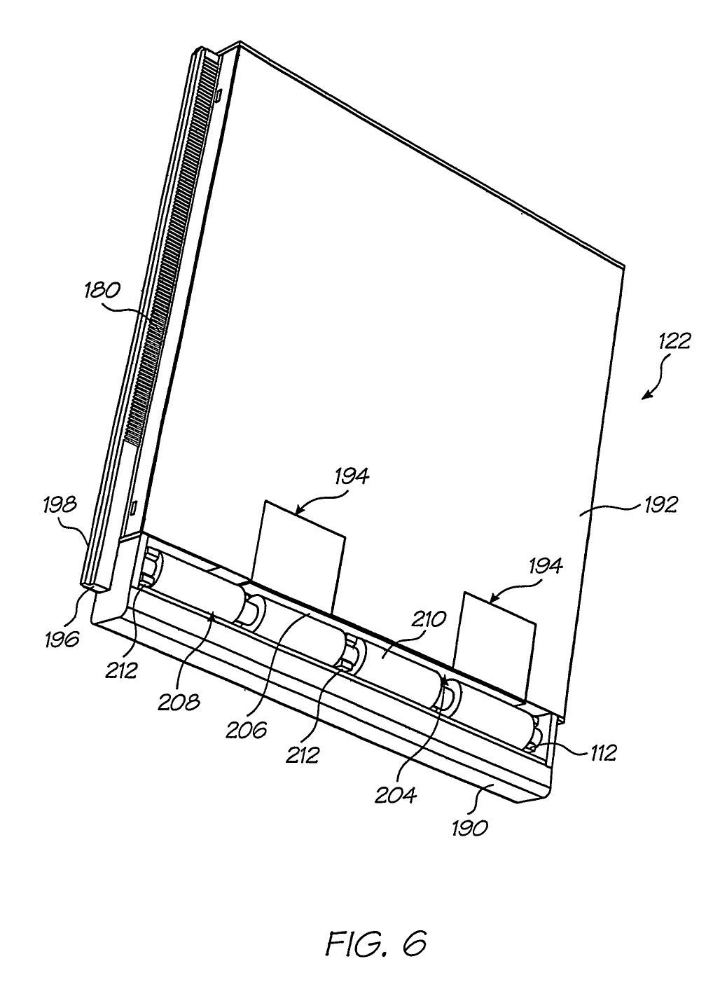

Referring to FIGS. 6 and 7 of the drawings, the cartridge 122 is described in greater detail.

The cartridge 122 comprises a base molding 190. A metal cover 192 closes off the base molding 190. The cover 192 has a pair of transversely spaced openings 194 defined in a front edge thereof. These openings 194 permit the pick up roller 168 of the printer 100 to engage a topmost sheet of the stack 170 of paper within the cartridge 122.

A toothed rack 196 is provided on one side of the cartridge 122. The toothed rack 196 defines the upper rack 180 which is engaged by a gear of the first gear train 144 for insertion of the cartridge 122 into, or its ejection from, the printer 100. A rib 198 extends longitudinally along the side of the toothed rack 196. The rib 198 is received in the slot 158 in the side molding 146 of the printer 100. A lower surface of the toothed rack 196 also has one of the longitudinally extending racks 200 (FIG. 7) for engagement with one of the cogs 164. An opposed side of the base molding 190 of the cartridge 122 carries the other of the longitudinally extending racks 202 which engages the other cog 164 for inhibiting skewing of the cartridge 122 when it is inserted into, or ejected from, the printer 100.

A feed slot 204 is defined at a front edge of the metal cover through which a sheet of paper to be printed is passed in use. The feed slot 204 is partially defined by a plastics strip 206 which inhibits more than one sheet of paper being fed to the printhead 300 at any one time.

A transversely extending trough 208 is defined outwardly of the strip 206. The trough 208 accommodates a sprung roller 210 therein. The roller 210 is supported in the trough 208 via a plurality of clips 212.

The roller 210 is biased upwardly relative to a base of the trough 208 via a plurality of leaf springs 214. The leaf springs 214 are formed integrally with an L-shaped metal bracket 216 which partially forms the trough 208. The roller 210 is a snap-fit in the clips 212.

A platen 218 is accommodated in the base molding 190. The platen 218 is spring biased via a plurality of leaf springs 220 which engage a floor 222 of the base molding 190 for urging the stack 170 of paper against the cover 192.

The ink supply reservoir 154 includes an ink supply molding 224 formed integrally with the base molding 190. The ink supply molding 224 defines a plurality of ink supply channels 226. Each ink supply channel 226 contains a particular color of ink. In this context, the term “colo” is to be understood as including inks which are invisible in the visible spectrum such as, for example, infra red inks.

The channels 226 are closed off by a flexible bladder-like membrane 228 which is heat-sealed to the molding 224. It will be appreciated that, as ink is withdrawn from each channel 226, the associated membrane 228 collapses into the channel 226 thereby inhibiting the ingress of air into that channel 226.

Each channel 226 communicates with an ink outlet 230. Each ink outlet 230 is in the form of a rupturable seal.

As shown in greater detail in FIG. 4 of the drawings, the ink supply manifold 156 of the printer 100 includes pins 232. These pins 232 communicate with the ink supply hoses 152. When the cartridge 122 is inserted into the printer 100, and the cartridge 122 is driven home by the gear train 144, the pins 232 pierce the seals 230 to place the hoses 152 in communication with their associated ink supply channels 226.

The cartridge 122 includes a quality assurance chip 234. This chip 234 ensures correct communications between the cartridge 122 and the printer 100 and that the cartridge 122 is of the required quality. The chip 234 communicates with the printer 100 via chip contacts 236 mounted on the ink supply manifold 156 of the printer 100. Thus, when the cartridge 122 is driven home by the gear train 144, the chip 234 engages the contacts 236 for enabling communications to be established between the chip 234 and the circuit board 136 of the printer 100.

The cartridge 122 is a disposable unit so that, once its ink supply and paper supply have been depleted, the cartridge is disposed of. Instead, the cartridge 122 may be re-useable. In the latter case, once the supply of ink and paper in the cartridge 122 have been depleted and the cartridge 122 is ejected from the printer 100, the used, empty cartridge 122 can be taken by a user to a supplier for a refund. It is to be noted that the cartridge 122 is automatically ejected from the printer 100 once its supply of paper and/or ink has been depleted.

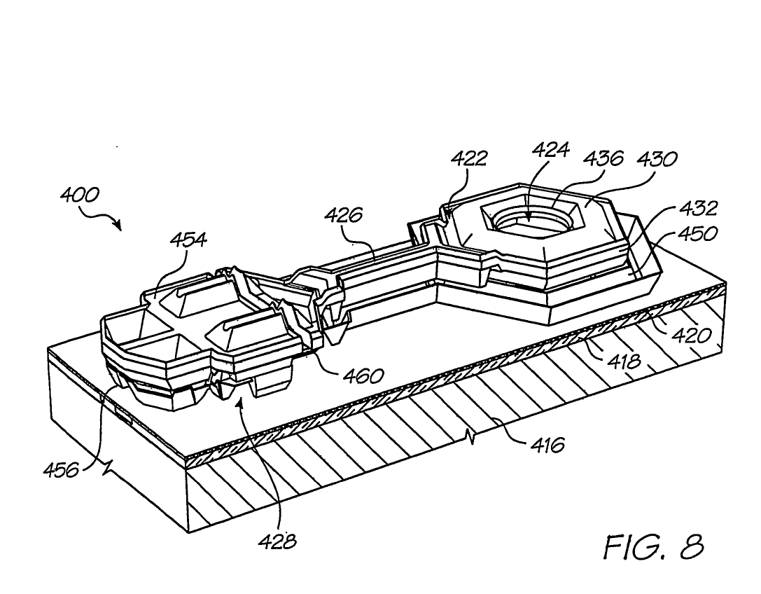

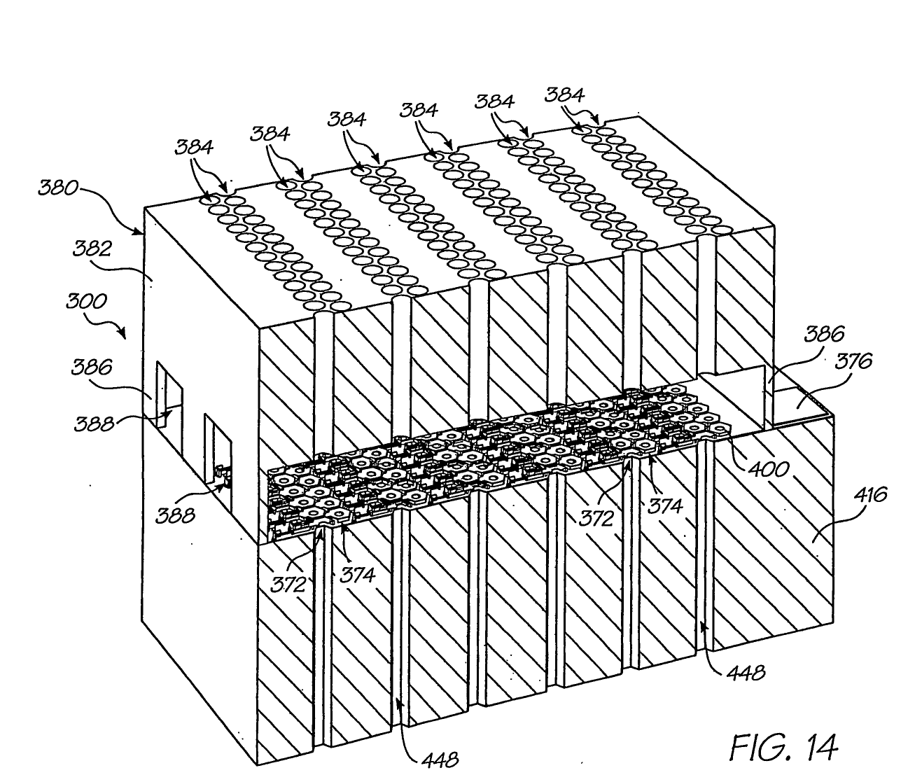

Referring to FIGS. 8 to 14 of the drawings, the printhead 300 is described in greater detail. The printhead 300 comprises an array, which will be described in greater detail below, of nozzle assemblies. Referring initially to FIG. 8 of the drawings, a nozzle assembly is illustrated and is designated generally by the reference numeral 400

The assembly 400 includes a silicon substrate or wafer 416 on which a dielectric layer 418 is deposited. A CMOS passivation layer 420 is deposited on the dielectric layer 418.

Each nozzle assembly 400 includes a nozzle 422 defining a nozzle opening 424, a connecting member in the form of a lever arm 426 and an actuator 428. The lever arm 426 connects the actuator 428 to the nozzle 422.

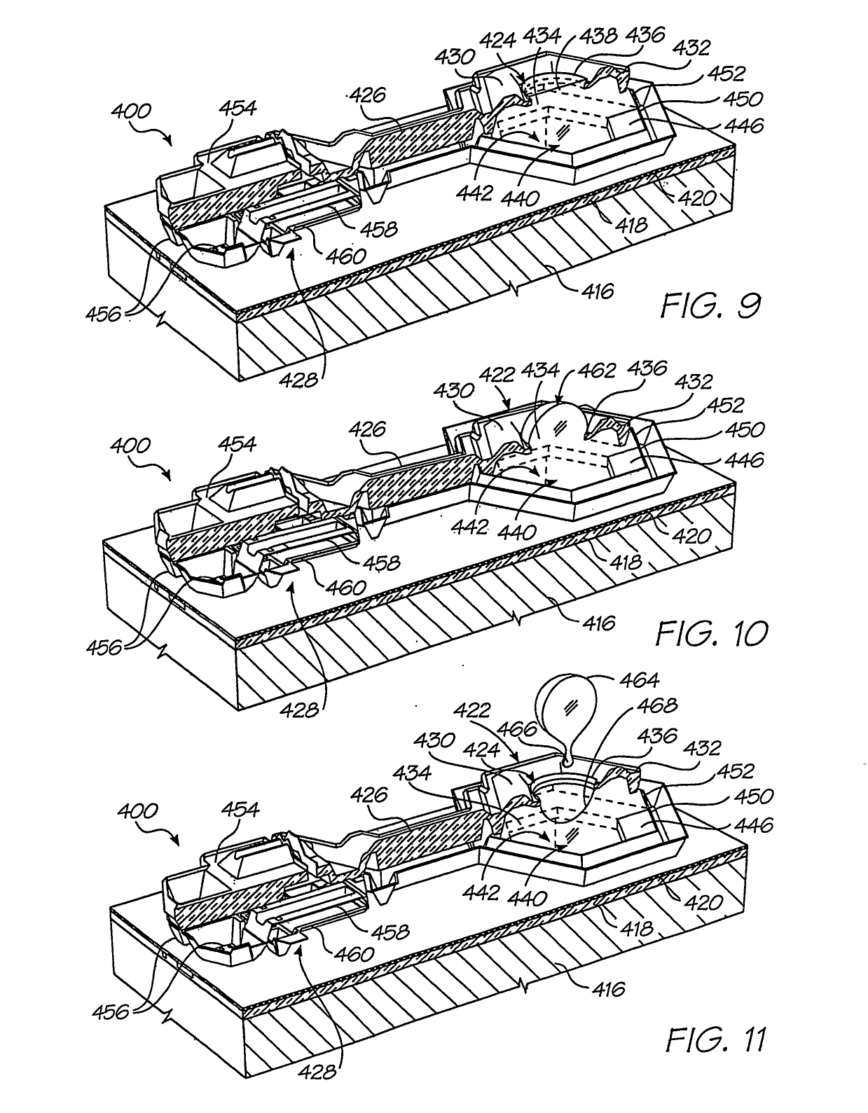

As shown in greater detail in FIGS. 9 to 11 of the drawings, the nozzle 422 comprises a crown portion 430 with a skirt portion 432 depending from the crown portion 430. The skirt portion 432 forms part of a peripheral wall of a nozzle chamber 434. The nozzle opening 424 is in fluid communication with the nozzle chamber 434. It is to be noted that the nozzle opening 424 is surrounded by a raised rim 436 which “pins” a meniscus 438 (FIG. 9) of a body of ink 440 in the nozzle chamber 434.

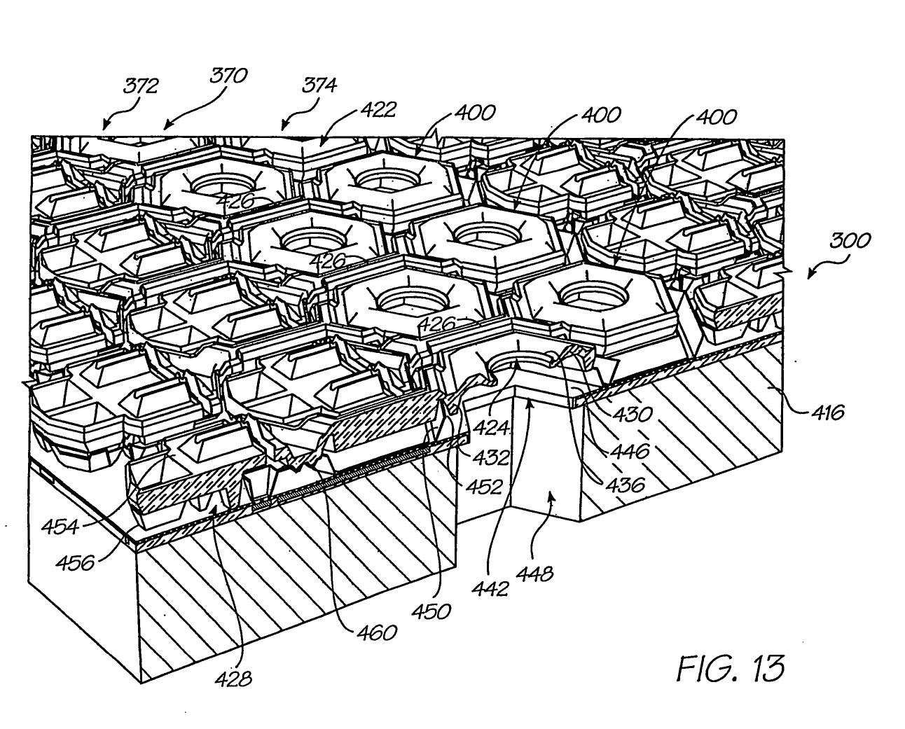

An ink inlet aperture 442 (shown most clearly in FIG. 13 of the drawings) is defined in a floor 446 of the nozzle chamber 434. The aperture 442 is in fluid communication with an ink inlet channel 448 defined through the substrate 416.

A wall portion 450 bounds the aperture 442 and extends upwardly from the floor portion 446. The skirt portion 432, as indicated above, of the nozzle 422 defines a first part of a peripheral wall of the nozzle chamber 434 and the wall portion 450 defines a second part of the peripheral wall of the nozzle chamber 434.

The wall 450 has an inwardly directed lip 452 at its free end which serves as a fluidic seal which inhibits the escape of ink when the nozzle 422 is displaced, as will be described in greater detail below. It will be appreciated that, due to the viscosity of the ink 440 and the small dimensions of the spacing between the lip 452 and the skirt portion 432, the inwardly directed lip 452 and surface tension function as a seal for inhibiting the escape of ink from the nozzle chamber 434.

The actuator 428 is a thermal bend actuator and is connected to an anchor 454 extending upwardly from the substrate 416 or, more particularly, from the CMOS passivation layer 420. The anchor 454 is mounted on conductive pads 456 which form an electrical connection with the actuator 428.

The actuator 428 comprises a pair of first, active beams 458 arranged above a pair of second, passive beams 460. In a preferred embodiment, both pairs of beams 458 and 460 are of, or include, a conductive ceramic material such as titanium nitride (TiN).

Both pairs of beams 458 and 460 have their first ends anchored to the anchor 454 and their opposed ends connected to the arm 426. When a current is caused to flow through the active beams 458 thermal expansion of the beams 458 result. As the passive beams 460, through which there is no current flow, do not expand at the same rate, a bending moment is created causing the arm 426 and, hence, the nozzle 422 to be displaced downwardly towards the substrate 416 as shown in FIG. 10 of the drawings. This causes ejection of ink through the nozzle opening 424 as shown at 462 in FIG. 10 of the drawings. When the source of heat is removed from the active beams 458, i.e. by stopping current flow, the nozzle 422 returns to its quiescent position as shown in FIG. 11 of the drawings. When the nozzle 422 returns to its quiescent position, an ink droplet 464 is formed as a result of the breaking of an ink droplet neck as illustrated at 466 in FIG. 11 of the drawings. The ink droplet 464 then travels on to the print media such as a sheet of paper. As a result of the formation of the ink droplet 464, a “negative” meniscus is formed as shown at 468 in FIG. 11 of the drawings. This “negative” meniscus 468 results in an inflow of ink 440 into the nozzle chamber 434 such that a new meniscus 438 is formed in readiness for the next ink drop ejection from the nozzle assembly 400.

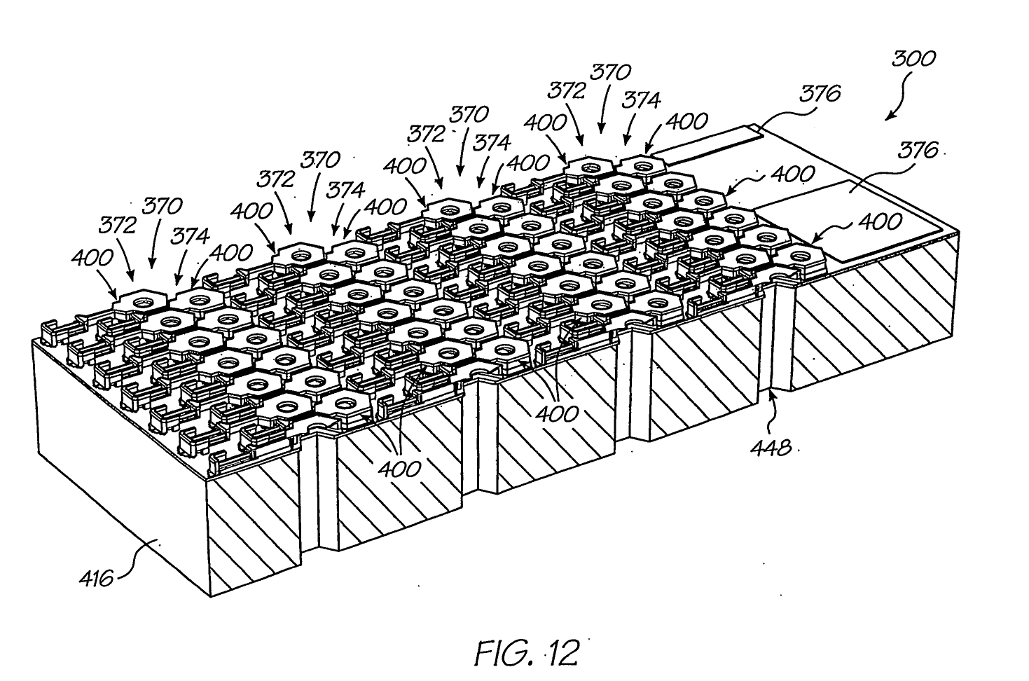

Referring now to FIGS. 12 to 14 of the drawings, a part of the printhead 300 is descnbed in greater detail. The printhead 300 is a four color printhead. Accordingly, the printhead 300 includes four groups 370 of nozzle assemblies, one for each color. Each group 370 has its nozzle assemblies 400 arranged in two rows 372 and 374. One of the groups 370 is shown in greater detail in FIG. 13 of the drawings.

To facilitate close packing of the nozzle assemblies 400 in the rows 372 and 374, the nozzle assemblies 400 in the row 374 are offset or staggered with respect to the nozzle assemblies 400 in the row 372. Also, the nozzle assemblies 400 in the row 372 are spaced apart sufficiently far from each other to enable the lever arms 426 of the nozzle assemblies 400 in the row 374 to pass between adjacent nozzles 422 of the assemblies 400 in the row 372. It is to be noted that each nozzle assembly 400 is substantially dumbbell shaped so that the nozzles 422 in the row 372 nest between the nozzles 422 and the actuators 428 of adjacent nozzle assemblies 400 in the row 374.

Further, to facilitate close packing of the nozzles 422 in the rows 372 and 374, each nozzle 422 is substantially hexagonally shaped.

The substrate 416 has bond pads 376 arranged thereon which provide the electrical connections, via the pads 456, to the actuators 428 of the nozzle assemblies 400. These electrical connections are formed via the CMOS layer (not shown).

A nozzle guard 380 is mounted on the substrate 416 of the printhead 300. The nozzle guard 380 includes a body member 382 having a plurality of passages 384 defined therethrough. The passages 384 are in register with the nozzle openings 424 of the nozzle assemblies 400 of the prnthead 300 such that, when ink is ejected from any one of the nozzle openings 424, the ink passes through the associated passage 384 before striking the print media.

The body member 382 is mounted in spaced relationship relative to the nozzle assemblies 400 by limbs or struts 386. One of the struts 836 has air inlet openings 388 defined therein.

When the printhead 300 is in operation, air is charged through the inlet openings 388 to be forced through the passages 384 together with ink travelling through the passages 384. The purpose of the air is to maintain the passages 384 clear of foreign particles. A danger exists that these foreign particles, such as dust particles, could fall onto the nozzle assemblies 400 adversely affecting their operation. With the provision of the air inlet openings 388 in the nozzle guard 380 this problem is, to a large extent, obviated.

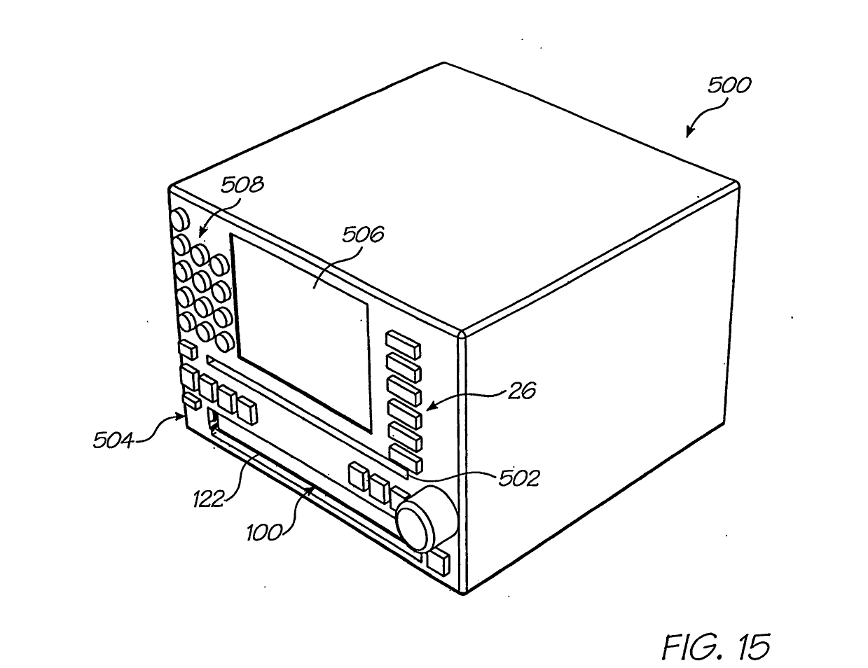

In another embodiment of the invention, the printer 100 is built into and forms part of an in-car entertainment (ICE) unit 500, as shown in FIG. 15 of the drawings.

The ICE unit 500, in addition to a CD player 502 and a radio having controls 504, includes a full color LCD 506. The unit 500 also functions as a television receiver. The unit 500 incorporates a printer 100 of the type described above. The unit 500 includes a bank of control buttons 508 for controlling operation of the LCD 506 when the unit is operating as a television receiver. In addition, the unit 500 includes the user terminal 26 which is provided for controlling the printer 100 and the content printed by the printer 100.

In use, when a broadcast signal is received and a user wishes to obtain further information relating to the broadcast the user operates the user terminal 26 to activate the tag look up unit 18. The tag look up unit 18 extracts the tag from the broadcast signal and retrieves information associated with the given tag by performing a look up of the tag.

The information retrieved by the tag look up unit 18 includes any kind of printable matter such as images or text. This information is transferred, potentially along with page layout information that may also be retrieved, to the layout engine 28.

The layout engine 28 performs layout of the data elements according to the layout information and generates a description of one or more pages in a suitable page description language such as postscript or PDF.

The description of each page is forwarded to the chain of modules of the processing means, more particularly the rasterization module 34 and the page compression module 38 where the data output by the layout engine 28 on line 32 are further manipulated into a suitable format for printing. The modules 34 and 38 produce one or more pages of output describing the currently playing audio or television content. This description may include such things as images relevant to the broadcast and details of a media (such as an album in the case of a piece of music) upon which the broadcast material or further material relating to the broadcast can be obtained.

This formatted data are forwarded to the printer controller 42 which activates the printer 100 and prints the information on a suitable media such as a sheet of paper.

One application of the present invention is its use in advertising, for example printing coupons or details of retailers.

In the case of an advertisement broadcast and received by the receiver 12 a special offer may be offered to listeners. By way of the printer 100 it is possible to produce one or more coupons that may be used at a later time to redeem the offer. Upon a listener hearing the advertisement in question, the listener activates the tag look up unit 18 via the user terminal 26. This causes the currently transmitted ancillary data to be decoded. If the ancillary data were in the form of a tag then a look up of this data would lead to one or more coupons being produced by the printer 100.

Similarly, an advertisement containing ancillary data referring to a particular retailer may be broadcast. In that case, if the listener actuated the user terminal 26 information regarding the retailer such as the name, location and contact details may be produced and printed by the printer 10.

Another application of the present invention is the on-selling of products for example music or videos.

It is quite common for a user listening to a radio broadcast to hear a song of which the listener is interested in obtaining a copy. If the ancillary data transmitted with the broadcast either contained or provided a reference to both information about a song and information about the media on which a song may be obtained (such as an album that included the song), this could be printed for the user on demand and later used to make a purchase.

A similar principle applies in respect of in-car television programs where a user watching a program may be interested in obtaining a copy of the program. Details of both the program and the media on which it may be obtained would in this case be encoded in the broadcast as ancillary data that may be printed by the user for references desired.

Accordingly, it is an advantage of the invention that a system 10 is provided which enables a user, by activating the user terminal 26, to have information relating to a broadcast printed in hard copy form. This could be by a simple activation of one or more buttons which greatly simplifies the listener's task and, in the case that the listener is also the driver, also enhances safety.

Still further, it is not necessary for a listener to attempt to grapple about within the vehicle looking for suitable paper and a writing implement to record information regarding a broadcast. Once again, by the simple manipulation of one or more buttons on the user terminal 26 this information can be downloaded and printed in a convenient format for later use.

In the case of advertising campaigns, the use of the printer and the system 10 enhances the reach of the advertising campaign and enable the listener to enjoy the benefits of any special offers.

Although the invention has been described with reference to a number of specific embodiments, it will be appreciated that the invention may be embodied in many other forms.

1. An information retrieval system for retrieving information relating to a broadcast received by a receiver, the system including:
a radio frequency receiver;
a detecting means for detecting identifying data relating to a particular broadcast received by the receiver, the identifying data being transmitted in association with the broadcast;
a processing means, in communication with said detecting means, for processing said identifying data to provide formatted data suitable for printing and for compressing said formatted data; and
a printing unit associated with said receiver the printing unit includes a printer controller, for receiving the compressed formatted data to be printed and decompressing the received data, and a printer for printing said formatted data to provide information relating to said broadcast.

2. The system of claim 1 in which the receiver is mounted in a conveyance and the printing unit is installed in said conveyance.

3. The system of claim 1 in which the identifying data comprises an identifying tag associated with the particular broadcast.

4. The system of claim 3 in which the detecting means comprises a tag look-up unit.

5. The system of claim 1 in which the broadcast is by way of an analog audio signal and the identifying data is inserted into the signal.

6. The system of claim 1 in which the broadcast is by way of a digital audio signal and the identifying data is inserted into an allocated data component of the signal.

7. The system of claim 1 in which the broadcast is by way of an analog video signal and the identifying data is inserted into the signal during a blanking period of the signal.

8. The system of claim 1 in which the broadcast is by way of a digital video signal and the identifying data is inserted into an allocated data component of the signal.

9. The system of claim 1 in which the receiver includes an actuating means operable by a user to activate the detecting means to detect the identifying data and to send the identifying data to the printing unit for printing.

10. The system of claim 1 in which the processing means includes a layout engine in communication with the detecting means.

11. The system of claim 10 in which the layout engine lays out data elements to be communicated to the printer so that, when printed on a stable print media, the data are presented in a visually discernible form.

12. The system of claim 10 in which the processing means further comprises a data manipulating means in communication with the layout engine for manipulating the data to provide the formatted data.

13. The system of claim 12, the manipulating means being adapted to rasterise the data.

14. The system of claim 13, the manipulating means being adapted to rasterise the data in a band-wise fashion to form a number of rasterised bands.

15. The system of claim 14, the processing means including a compression module for compressing the rasterised data, the compression module being adapted to compress each band separately.

16. The system of claim 1, the compression being at least one of:
JPEG
JBIG
Group 3 and 4 fax algorithms.

17. The system of claim 16 in which the printer comprises a pagewidth ink jet printhead.

18. The system of claim 17 in which the printhead comprises an array of nozzles, said array being fabricated by microelectromechanical techniques.

19. A method of retrieving information relating to a broadcast received by a receiver, the method including the steps of:
receiving a broadcast on a radio frequency receiver;
detecting identifying data relating to a particular broadcast received by the receiver, the identifying data being transmitted in association with the broadcast;
processing said identifying data to provide formatted data suitable for printing;
compressing said formatted data;
transferring said formatted data to a printer;
decompressing said compressed formatted data;
printing said formatted data to provide information relating to said broadcast.

20. The method of claim 19 in which the receiver is mounted in a conveyance and in which the method includes mounting a printer in the conveyance and printing the information via said printer.

21. The method of claim 20 which includes transmitting the identifying data as a tag associated with the particular broadcast.

22. The method of claim 21 which includes detecting the tag by means of a tag look-up unit.

23. The method of claim 19 in which the broadcast is by way of an analog audio signal and the method includes inserting the identifying data into the signal.

24. The method of claim 19 in which the broadcast is by way of a digital audio signal and the method includes inserting the identifying data into an allocated data component of the signal.

25. The method of claim 19 in which the broadcast is by way of an analog video signal and the method includes inserting the identifying data into the signal during a blanking period of the signal.

26. The method of claim 19 in which the broadcast is by way of a digital video signal and the method includes inserting the identifying data into an allocated data component of the signal.

27. The method of claim 19 which includes activating the detecting means to detect the identifying data and to send the identifying data to the printing unit for printing.

28. The method of claim 27 which includes manipulating said identifying data prior to printing to provide said formatted data.

29. An information retrieval system for retrieving information relating to a broadcast received by a receiver installed in a vehicle, the system including:
a radio frequency receiver;
an onboard detecting means for detecting identifying data relating to a particular broadcast received by the receiver, the identifying data being transmitted in association with the broadcast;
a processing means, in communication with said detecting means, for processing said identifying data to provide formatted data suitable for printing and compressing said formatted data; and
an onboard printing unit the printing unit includes a printer controller, for receiving the compressed formatted data to be printed and decompressing the received data, and a printer for decompress and printing said formatted data to provide information relating to said broadcast.

30. A method of retrieving information relating to a broadcast received by a receiver installed in a vehicle, the method including the steps of:
receiving a broadcast on a radio frequency receiver;
detecting identifying data relating to a particular broadcast received by the receiver, the identifying data being transmitted in association with the broadcast;
processing said identifying data to provide formatted data suitable for printing;
compressing said formatted data;
transferring said formatted data to a printer;
decompressing said compressed formatted data;
printing said formatted data on an onboard printing unit.

31. An information retrieval system for retrieving information relating to a broadcast received by a receiver installed in a vehicle, the system including:
a radio frequency receiver;
a tag identifying means for detecting and identifying an identifying tag transmitted in association with a particular broadcast received by the receiver;
an activating means, connected to the tag identifying means, operable by a user to activate the tag identifying means when the user wishes to obtain information relating to said broadcast;
a layout engine responsive to the tag identifying means for processing identifying data generated by the tag identifying means at least into textual data;
a pre-printing processing means which is connected to the layout engine and which processes the data to provide formatted data which is in a format which is suitable for printing and which compresses said formatted data; and
an onboard printer for decompressing and printing the formatted data, on demand, to provide a hard copy of the information relating to said broadcast.

32. A method of retrieving information relating to a broadcast received by a receiver installed in a vehicle, the method including:
receiving a particular broadcast on a radio frequency receiver;
detecting and identifying, by way of a tag identifying means, an identifying tag transmitted in association with said broadcast;
activating the tag identifying means when the user wishes to obtain information relating to the broadcast;
processing identifying data generated by the tag identifying means at least into textual data;
processing the textual data to provide formatted data which is in a format which is suitable for printing;
compressing said formatted data;
transferring said formatted data to a printer;
decompressing said compressed formatted data;
printing the formatted data, on demand, via an onboard printer contained in the vehicle, to provide a hard copy of information relating to said broadcast.
